(19) United States
(12) Patent Application Publication
(10) Pub. No.: US 2012/0270456 A1
(43) Pub. Date: Oct. 25, 2012

(54) FLAME RETARDANT FABRIC FOR PROTECTIVE CLOTHING

(75) Inventors: Alexander Gstettner, Laakirchen (AT); Tom Burrow, Derby (GB); Ulf Mathes, Schwanenstadt (AT)

(73) Assignee: Lenzingn AG, Lenzing (AT)

(21) Appl. No.: 13/505,398

(22) PCT Filed: Oct. 20, 2010
(86) PCT No.: PCT/AT2010/000397

§ 371 Date: Jul. 6, 2012

(30) Foreign Application Priority Data
Nov. 2, 2009 (AT) A 1731/2009

(51) Int. Cl. D03D 15/12; B32B 23/02

(52) U.S. Cl. 442/302; 428/221

(57) ABSTRACT

The product of the invention is a flame retardant fabric for use in personal protective clothing which provides a high level of protection from flames or other sources of heat characterized in that it is made from a mixture of a primary yarn which is a blend of FR cellulosic fibers with high temperature resistant polymer fibers and a secondary yarn which is a twisted yarn containing a continuous synthetic filament yarn.

### BACKGROUND OF THE INVENTION

1. Field of the Invention

It is well known that flame retardant fabrics especially those made from flame retardant fibers can be used to give protection against exposure to flame. It is normal practice that firefighters wear garments that will protect the user from flame in a hazardous situation. The garment is expected to prevent direct exposure to flames of the clothed user's skin, thereby reducing the risk of suffering burn injuries.

Other professions where protection from flame is required include police and security personnel, military personnel, workers in the gas and petroleum industries, welders, metal industry workers and utility workers who may be working on high voltage installations.

It is highly desirable that fabrics used in these applications should be comfortable to wear, should perform well physically and be aesthetically suited to the task—colour appearance and feel.

It is common for workers who use personal protective clothing to be working in a high stress environment with a high work load leading to high energy consumption. This leads to generation of heat and moisture inside the garment. It is highly desirable that fabrics used for the construction of the garments should be capable of dissipating heat and moisture to prevent over heating of the user. Fabrics that allow heat and moisture to escape produce garments that feel more comfortable to wear and also prolong the working time that can be achieved without exceeding maximum physiological stress levels.

It is well known that cellulosic fibers can give enhanced comfort compared to synthetic fibers. This is because cellulosic fibers are hydrophilic and absorb moisture vapour and liquid water. Controlling the movement and distribution of water in the fabric is an inherent property of a cellulosic fiber.

In the intended applications, fabrics are expected to be unaffected by all activities that they are subject to. This means they need to have high tear strength, high abrasion resistance and good resistance to snagging.

Fabrics also need to retain their appearance over a prolonged period of use and care. Therefore fabrics need to be washable and have good washing stability, low shrinkage, good pilling performance, and good colour fastness to washing and light.

It is common for organizations that equip workers with personal protective clothing to require that the clothing conforms to the organization's corporate colours. There are also many cases where the colour of a garment is important for its function such as black for riot police or high visibility yellow, orange or green for firefighters. Therefore it is highly desirable that fabrics used for these applications can be dyed easily to a wide range of colours and give good fastness performance.

2. Description of Related Art

Textile materials vary considerably in their ability to resist flame and hence protect underlying materials. Most fabrics made from natural fibers and from synthetic fibers will burn when exposed to flame. The rate of burn and ease of ignition are determined primarily by the chemical nature of the polymer from which the fiber is made and the construction of the fabric. Many polymers, such as cellulose, polyester and nylon will burn readily. The rate of burn is lower the heavier a fabric is. Wool is the most common fiber which has flame retardant properties to some degree—heavy weight wool fabrics will not burn readily and are used in firefighter's clothing.

Fabrics can be treated to make them flame retardant by applying an appropriate chemical to the fabric. The first FR treated fabrics used inorganic salts such as aluminium hydroxide, antimony trioxide and borates to make cotton fabrics flame retardant. These were effective but were non-durable to washing.

Organic phosphorous containing compounds that are reacted onto the cotton either by grafting or network formation are more durable and are widely used. Two of the leading brand names are Proban® and Pyrovatex®. While these finishes are durable, they can be removed by harsh chemical treatments and the level of finish reduces with the number of washing cycles. The finish application has an adverse stiffening effect on the fabric. Fabrics of this type are in use for protection from flame.

The first flame retardant man made fibers produced were made by the viscose process. A high viscosity liquid flame retardant additive was dispersed in the spinning solution prior to extrusion of the fiber. The liquid was trapped in the cellulose by physical means as very small bubbles. The result was effective as a flame retardant fiber, but the additive could be removed by repeated washing. The strength of the fiber is reduced in proportion to the amount of additive included. The additive was withdrawn from the market due to safety concerns and production of the fiber was discontinued.

An improved flame retardant viscose fiber can be produced by using a solid pigment flame retardant. Fiber of this type will be referred to as FR viscose. The pigment is finely ground and mixed with the spinning solution prior to extrusion of the fiber. The result is a dispersion of the insoluble particulate additive in the fiber. The strength of the fiber is reduced in proportion to the amount of additive included. All of the cellulose in the fiber contains some of the additive and the additive cannot be removed by washing or normal fabric dyeing or finishing processes. Hence the result of the process is an inherently flame retardant fiber. A well-known fiber of this kind is Visil®, which contains silica pigment flame retardant.

A further improvement can be achieved by incorporating the solid pigment flame retardant in the spinning solution used to produce modal fiber. The modal process is a modified viscose process designed to produce a fiber with a higher strength and higher wet modulus than normal viscose. The resultant fiber containing the flame retardant pigment is inherently flame retardant. It is stronger than fiber produced by the viscose process and gives fabrics with higher strength and better stability. Fiber of this type will be referred to as FR Modal but note that the properties of the fiber do not conform to the BISFA definition of modal fiber. Proven flame retardant pigments for this kind of fibers are organic phosphorous compounds and a preferred pigment is Exolith® (2′-oxybis[5,5-dimethyl-1,3,2-dioxaphosphorinan]2,2′disulfid).

FR Modal is used in 100% form in only a few applications in the field of apparel such as metallised fabrics or fabrics which are mixtures of two or more yarns. On its own its performance is inadequate in a number of respects compared to other products.

In the same way Lyocell fibers can be made flame retardant. Due to the different manufacturing conditions usually different pigments are suitable. Fiber of this type will be referred to as Lyocell FR.

An alternative approach to producing an FR fiber is to modify the polymer from which the fiber is made so that it is inherently flame retardant but can still be formed into a fiber. There are many examples of such fibers but the leading ones being used in personal protective clothing are meta-aramid, para-aramid, Polybenzimidazole (PBI), FR polyester and modacrylic.

Flame retardant fibers can often be used on their own to make fabrics which function well. They can also be used in blends with each other and with non flame retardant fibers to produce fabrics. Such blend fabrics can have properties which are a combination of the properties of the component fibers.

There are many flame retardant fabrics available in the market. The most widely used in personal protective clothing are: Flame retardant finished 100% cotton; Flame retardant finished cotton/polyamide blend (typically 85/15); Flame retardant finished polyester/cotton blend (typically 50/50); Modacrylic/cotton blend (typically 55/45); Modacrylic/cotton aramid blend (typically 25/25/50); Modacrylic/lyocell/aramid blend (typically 25/25/50); 100% meta-aramid; Meta-aramid/para-aramid blend (typically 80/20); Meta-aramid/FR Modal blend (typically 70/30).

Each of these fabrics has its merits and deficiencies, as can be seen from Table 2 in Example 2. The fabric selection process used by garment makers and specifiers is based on a judgment of the overall performance and the required level based on risk analysis. None of the fabrics provides all of the criteria of an ideal fabric.

FR treated cotton and cotton blend fabrics give poor to medium performance, fair comfort, relatively easy processing and are the most affordable. Modacrylic blends give fair performance but poor comfort and cost more. Aramid fabrics give good performance and washing performance but are not comfortable and are expensive.

Adding FR Modal to an aramid fabric improves its overall performance and reduces the cost.

Each of the fabrics has deficiencies in one or more respects. No single fabric has given good all-round performance, comfort, processability and care properties at a reasonable cost. This is the target of the invention.

### SUMMARY OF THE INVENTION

The objective of this invention is to produce a fabric for use in personal protective clothing which resolves the deficiencies of the prior art described above. It should show excellent performance in terms of safety of the user but at a lower cost and with better comfort and aesthetic properties than current products to ensure that garments made from it have all of the required performance for the intended applications.

Current products in the market perform well in protecting the user, but they are expensive which means their use is limited. They are made from, at least in part, fibers with poor comfort and aesthetic properties and they can be difficult to produce because of poor dyeability. There was a need for a fabric which will deliver:

Protection
Inherently Flame retardant for the life of the product
Cool to the touch immediately after exposure to flame
Very good break open behaviour; the fabric remains intact even after exposure to flame
Very good insulation against heat and flame

Mechanical Performance Durability:
Extremely high tear resistance.
Low Pilling
Excellent abrasion properties.

Physiological Performance:
Better thermal properties giving more efficient cooling,
Improved physiological performance of the user

Comfort:
Higher and more rapid moisture absorption
Better short-term water absorption capacity
Cool touch

Processability
Fabric can be piece dyed
Very high colour fastness
Wide range of colours achievable
Fabric printable using vat or reactive dye systems

Washing Performance
Stable to washing
Low washing shrinkage

Environment/Sustainability
Fibers which are ÖKOTEX Standard 100
Fibers which are highly sustainable

### DETAILED DESCRIPTION OF THE INVENTION

The product of the invention is a flame retardant fabric for use in personal protective clothing which provides a high level of protection from flames or other sources of heat characterized in that it is made from a mixture of a primary yarn which is a blend of FR cellulosic fibers with high temperature resistant polymer fibers and a secondary yarn which is a twisted yarn containing a continuous synthetic filament yarn.

The blend ratio of the primary yarn is preferably 70 to 90% FR cellulosic fibers and 10 to 30% high temperature resistant polymer fibers, more preferably 80 to 90% FR Modal and 10 to 20% high temperature resistant polymer fibers.

The FR cellulosic fiber of the primary yarn is a cellulosic fiber that has been made flame retardant by addition of an FR agent during or after fiber production.

The FR cellulosic fibers of the primary yarn are chosen from the group consisting of FR Modal, FR viscose and FR Lyocell. More specifically the FR cellulosic fibers of the primary yarn are FR Modal fibers.

The high temperature resistant polymer fibers are chosen from the group consisting of para-aramid, meta-aramid and PBI as well as blends of these fibers. Preferably the high temperature resistant polymer fibers are para-aramid fibers.

The secondary yarn is a twisted yarn containing a continuous synthetic filament yarn. In one embodiment this secondary yarn consists only of the continuous synthetic filament yarn. In another embodiment this secondary yarn consists of a continuous synthetic filament yarn twisted with a yarn with the same composition as the primary yarn used in the respective fabric.

In all embodiments described herein the synthetic filament yarn is chosen from the group consisting of PA 6, PA6.6, PES and aramid filament yarns. Preferably the continuous synthetic filament yarn in the secondary yarn is PA 6 filament yarn and especially preferred is a high-tenacity PA 6 filament.

More specifically the product of the invention in one embodiment is a fabric consisting of a primary yarn, which is a blend of FR Modal and a para-aramid or meta-aramid or blend of the two aramids plus a secondary yarn which is a twisted, 100% continuous filament, polyamide (nylon). The fabric may be woven or knitted.

More specifically the product of the invention in another preferred embodiment is a fabric consisting of a primary yarn, which is a blend of FR Modal and a para-aramid or meta-aramid or blend of the two aramids plus a secondary yarn which is the result of twisting together a continuous polyamide (nylon) filament and a yarn which is a blend of FR Modal and a para-aramid or meta-aramid or a blend of FR Modal with the two aramids. Even more specifically the secondary yarn in this embodiment is the result of twisting together a continuous filament, polyamide (nylon) yarn and a yarn with the same composition as the primary yarn. The fabric may be woven or knitted.

The woven fabric has a warp and weft composed mainly of the primary yarn with e.g. every sixth thread in the warp and weft replaced by the secondary yarn to give a grid pattern of the secondary yarn. In particular it is constructed so that the secondary yarn occurs in the warp and the weft at a frequency of every 4 to 20 yarns, preferably every 5 to 8 yarns to give a grid pattern of the secondary yarn. A weft knitted fabric has about five courses of the primary yarn and one course of the secondary yarn.

The fabric has exceptional flammability and protective performance. It will not burn, it does not break open when exposed to a flame and continues to provide a barrier to flame. This has previously only been possible with much more expensive fabrics such as PBI, 100% para-aramid or Lenzing FR/meta-aramid blends and inorganic based fibers.

All of this is achieved with a fabric that has a lower production cost than other fabrics with similar performance and the fabric is much more comfortable because of the high proportion of cellulosic fibers.

The primary yarn is produced from staple fiber by spinning the yarn using conventional techniques such as ring spinning, open end spinning, vortex spinning, worsted spinning, semi-worsted spinning or any of the variations on these used in the yarn spinning industry. The staple length of the fibers for the primary yarn may be between 35 mm up to 160 mm and preferably 75 to 110 mm. The staple length will need to be appropriate to the spinning system selected.

The secondary yarn preferably has a yarn count that is similar to the yarn count of the primary yarn. However, depending on the tear strength required for the application that is being targeted, the secondary yarn may be finer or coarser than the primary yarn.

The linear density (=titer) of the fibers and filaments used in the fabric will be chosen dependant on the intended application. Generally it will be in the range commonly used for such textile applications. The linear density will depend on the yarn spinning system used for the primary yarn.

During the preparatory processes prior to spinning the primary yarn the FR Modal fiber and the para-aramid fiber are blended together in the required proportions. The primary yarn is an intimate blend of the two fibers with the para-aramid fiber well dispersed throughout the final yarn. This blending can be done during opening of the fibers, during carding or during drawing of the sliver.

The blend ratio of the primary yarn according to the invention is preferably 70 to 90% FR Modal and 10 to 30% para-aramid, more preferably 80 to 90% FR Modal and 10 to 20% para-aramid. The proportion of para-aramid fiber in the yarn may be up to 30%, but the cost of the fabric increases with increasing para-aramid content with no appreciable increase in performance against the applicable standards.

The fabric weight, construction and weave of the woven fabric are selected to deliver a fabric of the style and properties required for the application. E.g. the fabric construction may be a plain weave, twill, hopsack, satin, sateen or any other weave which is appropriate to a protective clothing application. For knitted fabrics a plain jersey, pique or any other suitable fabric construction is possible. The fabric may be a lightweight (i.e. a weight per unit area of 100 to 150 g/m²) plain weave for shirting applications. It may be a medium weight (i.e. a weight per unit area of 150 to 230 g/m²) twill weave for trousers. It may also be a heavyweight (i.e. a weight per unit area of 230 to 350 g/m²) twill weave for jackets and other outerwear. The basic principle of the invention can be incorporated in a wide variety of fabrics. It will work regardless of the weave or construction, provided the correct blends and arrangements of yarns are used. Only exceptionally lightweight fabrics (less than 100 g/m²) would not show the benefits of the invention.

The product of this invention is intended to be used as one of the primary components of clothing for personal protection in situations where there is a risk of exposure to flame. The fabric is used to make garments that cover the body of the user to protect the skin from exposure to flames or other sources of heat that would cause injury.

Garments are usually made by assembling cut shaped pieces of fabric by sewing them together. The product of this invention may be the sole fabric used in making a garment or may be one component of a garment; the other components consisting of fabrics of different design and purpose. It may also be combined with other fabrics by laminating prior to cutting the shaped pieces for garment assembly.

The product of this invention may be used as a layer of fabric on the inside of a garment. It may be used as a layer on the outside of a garment or it may be used as an internal component between two or more other fabrics. It may also be used to provide more than one layer in the garment. For example it could be used as the inner layer of the garment and as the outer layer of the garment with a third layer of a flame retardant wadding between the inner and outer layers.

The product of the invention may be used for the production of all types of garments where protection from flames is a primary purpose. It can be used for jackets, coats, trousers, shirts, sweaters and jumpers, sweatshirts, T-shirts, socks, aprons, gloves and gauntlets, hoods for head protection other headwear and any other garment that may be worn for the purpose of protecting the wearer from flame. The fabric may also be used in other articles which are intended to provide protection of people or property from exposure to flame such as shoe and boot components, welding screens, fire curtains, tents, sleeping bags, tarpaulins and any other similar articles made in whole or in part from fabric.

Coloured fabrics for the intended applications are preferably achieved by using spun dyed fires, by piece dyeing or by printing, but in general all dyeing techniques are applicable.

### EXAMPLES

### Example 1

A twill weave fabric was woven from the following components:
Primary yarn: A Nm 50/2 worsted spun yarn in which 90% of the fiber was 3.3 dtex Lenzing FR® (⅓ with 75 mm and 2/3 with 90 mm staple length) and 10% of the fiber was 1.7 dtex 100 mm staple length para-aramid. Lenzing FR® is an FR modal fiber available from Lenzing AG, Austria, which is produced according to a modal process (see AT-A 1371/2009) and which contains Exolith® as an FR pigment. The two fiber components were blended together in drafting of the slivers during preparatory processing.
Secondary yarn: A secondary yarn was formed by twisting together the primary yarn and a 235 dtex, 34 filament nylon 6.6 high tenacity continuous filament yarn. The resulting yarn had a yarn count of Nm 50/2.
The fabric warp count was 30 threads per cm. The weft count was 26 threads per cm.
In the warp the two component yarns were arranged so that 5 adjacent yarns were the primary yarn and the sixth yarn was the secondary yarn repeated across the whole of the width of the warp.
The weft yarn was interlaced with the warp yarn in such a way that five yarns in succession were the primary yarn and the sixth yarn was the secondary yarn repeated throughout the length of the fabric woven.
The resulting fabric had a mass per unit area of 250 g/m². The secondary yarns formed a rectangular grid pattern which was visible over the whole of both surfaces of the fabric.
The resulting fabric could not be ignited in normal atmospheric conditions. On exposure to flame directed at the surface of the fabric, the fabric charred but maintained its structure and continued to act as a barrier to flame. No holes were formed in the fabric.
Afterflame and afterglow of the fabric when tested according to EN ISO 15025 were 0 seconds in the warp direction and 0 seconds in the weft direction.
The tear test results were as follows compared to some other products used in personal protective clothing in table 1:

TABLE 1
Fabric Performance Results

| | | | | Heat | | |
|---|---|---|---|---|---|---|
| | Fabric | Warp | Weft | pene- | Water | |
| | weight | tear | tear | tration | vapour | Colour |
| Fabric | (g/m2) | strength | strength | coefficient | absorption | Fastness |
| Fabric | 250 | 61 | 50 | 173 | 10.5 | 5 |
| of the | | | | | | |
| Invention | | | | | | |
| (example | | | | | | |
| 1) | | | | | | |
| Moda- | 260 | 25 | 25 | 126 | 4.3 | 4 |
| crylic/ | | | | | | |
| cotton | | | | | | |
| FR treated | 340 | 30 | 30 | 139 | 9.1 | 3 |
| cotton | | | | | | |
| Aramid | 260 | 52 | 50 | 109 | 2.3 | 3 |

This shows that the secondary yarn included in the fabric is effective at giving the fabric a high tear strength.
The fabric was tested for its comfort properties. The Alambeta test measures the rate of transmission of heat through the fabric. Fabrics with a high heat transmission, i.e. a high Heat penetration coefficient, feel cooler and this makes them more comfortable to wear.
The fabric was tested for short term water vapour absorption using the human skin model apparatus. A high water vapour absorbency indicates the fabric is capable of positively managing the moisture in its environment. This helps to keep the body dry and cool.

### Example 2

The fabric of example 1 was assessed subjectively and compared to commercially available fabrics used for Personal Protective Clothing. The results are given in Table 2, last column.

In every parameter judged, the fabric of example 1 was given the highest possible score. In this table the scoring system is 1 to 3−1=poor, 3=excellent

TABLE 2
Properties of commonly used Personal Protective Clothing Fabrics compared to example 1

| | | | | | | | | | |
|---|---|---|---|---|---|---|---|---|---|
| | | | | | | | | | FR Modal/ |
| | | | | | | | Meta- | Meta- | para- |
| | | | | MAC/ | MAC/ | 100% | aramid/ | aramid/ | aramid/ |
| | FR cotton/ | FR poly/ | MAC/ | cotton/ | lyocell/ | meta- | para- | FR | nylon |
| FR cotton | PA | cotton | cotton | aramid | aramid | aramid | aramid | Modal | (ex 2) |

Protection

| | | | | | | | | | | |
|---|---|---|---|---|---|---|---|---|---|---|
| Inherently FR | 1 | 1 | 1 | 2 | 2 | 2 | 3 | 3 | 3 | 3 |
| break open behaviour | 1 | 1 | 1 | 2 | 2 | 2 | 1 | 2 | 3 | 3 |
| insulation | 2 | 2 | 2 | 2 | 2 | 2 | 3 | 3 | 2 | 3 |

Mechanical Performance Durability:

| | | | | | | | | | | |
|---|---|---|---|---|---|---|---|---|---|---|
| tear resistance. | 1 | 1 | 2 | 1 | 2 | 2 | 3 | 3 | 3 | 3 |
| Pilling | 2 | 2 | 2 | 1 | 1 | 2 | 2 | 2 | 3 | 3 |
| abrasion properties | 1 | 2 | 2 | 1 | 1 | 1 | 3 | 3 | 3 | 3 |

Physiological Performance:

| | | | | | | | | | | |
|---|---|---|---|---|---|---|---|---|---|---|
| thermal properties | 2 | 2 | 2 | 2 | 2 | 2 | 1 | 1 | 3 | 3 |
| user performance | 2 | 2 | 2 | 1 | 1 | 1 | 2 | 2 | 3 | 3 |

Comfort:

| | | | | | | | | | | |
|---|---|---|---|---|---|---|---|---|---|---|
| moisture absorption | 3 | 2 | 2 | 2 | 1 | 1 | 1 | 1 | 2 | 3 |
| Cool touch | 2 | 2 | 1 | 1 | 1 | 2 | 1 | 1 | 2 | 3 |

Processability

| | | | | | | | | | | |
|---|---|---|---|---|---|---|---|---|---|---|
| piece dyeable | 3 | 3 | 3 | 2 | 2 | 2 | 1 | 1 | 2 | 3 |
| colour fastness | 1 | 1 | 1 | 1 | 2 | 2 | 1 | 3 | 2 | 3 |
| Colour range | 3 | 3 | 3 | 2 | 2 | 2 | 1 | 1 | 2 | 3 |
| Fabric printable | 3 | 3 | 3 | 2 | 2 | 2 | 1 | 1 | 2 | 3 |

Washing Performance

| | | | | | | | | | | |
|---|---|---|---|---|---|---|---|---|---|---|
| Stable to washing | 1 | 1 | 2 | 1 | 2 | 2 | 3 | 3 | 3 | 3 |
| Low washing shrinkage | 1 | 1 | 2 | 2 | 2 | 3 | 3 | 3 | 3 | 3 |

Environment/Sustainability

| | | | | | | | | | | |
|---|---|---|---|---|---|---|---|---|---|---|
| ÖKOTEX Standard 100 | 1 | 1 | 1 | 1 | 1 | 1 | 2 | 2 | 2 | 3 |
| sustainability | 1 | 1 | 1 | 1 | 1 | 1 | 1 | 1 | 2 | 3 |
| Affordability | 3 | 3 | 3 | 2 | 2 | 2 | 1 | 1 | 2 | 3 |

What is claimed is:

1. A flame retardant fabric for use in personal protective clothing which provides a high level of protection from flames or other sources of heat wherein said fabric is made from a mixture of a primary yarn which is a blend of FR cellulosic fibers with high temperature resistant polymer fibers and a secondary yarn which is a twisted yarn containing a continuous synthetic filament yarn.

2. Fabric according to claim 1, wherein the blend ratio of the primary yarn is 70 to 90% FR cellulosic fibers and 10 to 30% high temperature resistant polymer fibers, more preferably 80 to 90% FR Modal and 10 to 20% high temperature resistant polymer fibers.

3. Fabric according to claim 1, wherein the FR cellulosic fibers of the primary yarn are cellulosic fibers that have been made flame retardant by addition of an FR agent during or after fiber production.

4. Fabric according to claim 1, wherein the FR cellulosic fibers of the primary yarn are chosen from the group consisting of FR Modal, FR viscose and FR Lyocell.

5. Fabric according to claim 1, wherein the FR cellulosic fibers of the primary yarn are FR Modal fibers.

6. Fabric according to claim 1, wherein the high temperature resistant polymer fibers are chosen from the group consisting of para-aramid, meta-aramid, PBI and blends of these fibers.

7. Fabric according to claim 1, wherein the high temperature resistant polymer fibers are para-aramid fibers.

8. Fabric according to claim 1, wherein the secondary yarn consists only of twisted continuous synthetic filament yarn.

9. Fabric according to claim 1, wherein the secondary yarn consists of a continuous synthetic filament yarn twisted together with a yarn with the same composition as the primary yarn used in the respective fabric.

10. Fabric according to claim 1, wherein the continuous synthetic filament yarn is selected from the group consisting of PA6, PA6.6, PES and aramid filament yarns.

11. Fabric according to claim 1, wherein the continuous synthetic filament yarn is PA6 filament yarn.

12. Woven fabric according to claim 1, wherein the fabric is constructed so that the secondary yarn occurs in the warp and the weft at a frequency of every 4 to 20 yarns, preferably every 5 to 8 yarns.
